(19) United States
(12) Patent Application Publication
(10) Pub. No.: US 2007/0191979 A1
(43) Pub. Date: Aug. 16, 2007

(54) Method, program and apparatus for supporting inter-disciplinary workflow with dynamic artifacts

(75) Inventors: Sai Zeng, Hawthorne, NY (US); Jose Gomes, Douglaston, NY (US); Man-Mohan Singh, Yorktown Heights, NY (US); Ioana Boier-Martin, Hawthorne, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/350,927

(22) Filed: Feb. 10, 2006

(51) Int. Cl. G06F 19/00

(52) U.S. Cl. 700/97

(57) ABSTRACT

A computer-implemented method, program and apparatus supporting collaborative product development, that includes, maintaining under revision control, in a first repository, a plurality of artifacts, and in another repository, a plurality of artifact tuples. At least one first artifact tuple including first access information providing access to at least one of the plurality of artifacts, and at least one second artifact tuple including second access information providing access to at least one other of the plurality of artifact tuples. The method, program and apparatus also maintains under revision control, at least one workflow activity description and at least one artifact configuration selection rule. The method, program and apparatus further associates the workflow activity description with at least one of the plurality of artifact tuples, and associates the workflow activity description with the at least one artifact configuration selection rules.

### FIELD OF THE INVENTION

This invention relates generally to product development and, more specifically, relates to computer-aided product development.

### BACKGROUND OF THE INVENTION

1. Modern product development

Product development is becoming increasingly complex. Take, as illustrations, the three concepts of computer-aided engineering (CAD), product data management (PDM), and Workflow Management (WFM). These concepts have revolutionized mechanical engineering in the automotive industry and other industries.

1.1. CAD

In the past, automotive parts would have to be drawn entirely by hand and developed by engineers who had to manually integrate the parts with other parts in the automobile. An advance over that type of product development was computer-aided design (CAD) tools, which allowed two-dimensional and three-dimensional product design and could include parts lists and even costs for the resulting product.

1.2. PDM

PDM systems typically manage artifacts during the product lifecycle. Artifacts are finite and identifiable pieces of digital information produced, consumed or transformed by product development processes.

For instance, an artifact could be an abstraction, such as a CAD model file, a digital representation of a product simulation process, or a record in a database of a design specification.

PDM systems include repositories that maintain artifacts under revision control. Revision control reduces the chance of accidental deletion of artifacts, controls modification and creation of artifacts, provides the ability to return to a previous revision, and provides a history of the lifecycle of a product.

1.3. WFM

Workflow Management is an approach to manage the sequence of work activities and invocation of human and IT resources associated with corresponding activities, and therefore, facilitates automating the process involving both human based and computer based activities. Therefore, workflow is an embodiment of the product development process.

Workflow Management allows scheduling of resources, such as engineers, to design tasks, provide time schedules for tasks, and status monitoring of tasks.

A workflow is composed of activities, roles, workflow details and artifacts which represent the input and output of the activities.

An activity is a unit of work that provides a meaningful result in the context of an action by a human or an IT resource. It has a clear purpose, which usually involves creating updating, or consulting artifacts. Every activity is assigned to a specific role. Activities may be repeated several times.

A role defines the behavior and responsibilities of an individual, or a set of individuals working together as a team, within the context of a specific discipline or domain involved in product development process. A role is responsible for one or more artifacts, and performs a set of activities.

A workflow detail is a grouping of activities that are often performed together to produce a specific result. In particular, workflow details describe groups of activities performed together in a discipline. Within a workflow detail, activities may be performed in parallel, and each activity may affect more than one artifact. Workflow detail information includes the key artifacts, activities, and roles involved in a workflow detail.

Workflow systems typically provide two functions: process definition; and process enactment.

Process definition is responsible for defining and possibly modeling the process and constituent activities.

Process enactment is responsible for invoking the workflow, instantiating the workflow, and interacting with human and IT resources to execute various activity steps.

2. Systems Engineering

Concepts similar to CAD, PDM and WFM exist in engineering domains other than mechanical engineering, such as electrical, electronics, software engineering, etc.

In software engineering, for instance, the equivalents of CAD, PDM and WFM would respectively be software code artifacts, software configuration management (SCM) systems and workflow management system applicable to software engineering processes.

While PDM and SCM are useful for their respective domains, new products being designed currently incorporate mechanical, electronics and software components. For instance, automobiles today typically have at least an engine control unit (ECU) controlling functions of the engine and generally have many other embedded control systems operating everything from automatic climate control to informational displays, to global positioning satellite (GPS) displays and interfaces. Additionally, there is an industry-wide effort to consider the promises of Requirements Engineering, Systems Engineering or Model-Driven Development disciplines, each with its own set of artifacts, as applied to the development of a “whole” product.

2.2. System Data Management (SDM)

Applicant's invention disclosure (U.S. Patent Application No. YOR9-2005-0026) describes an exemplary system data management. According to the SDM concept, discipline-specific artifacts remain under the management of their respective teams and repositories. The inter-disciplinary traceability information is explicitly captured and managed in an additional discipline-agnostic repository called the SDM Repository. Within this repository, the traceability information is organized and managed according to the needs of the prescribed inter-disciplinary processes associated with the system being developed. For each such process, the SDM repository maintains references to the set of multi-disciplinary artifacts (seen as concrete resources) needed to execute it. The integrity of the traceability information is guarantied through the enforcement of a collaboration protocol between discipline-specific repositories and the SDM repository.

2.3 Process-centric traceability

Application of WFM concepts in systems engineering involves management of the inter-disciplinary processes, where each activity might be associated with artifacts from multiple disciplines through traceability information and references described earlier. This process-centric information is kept under revision control in SDM.

A challenge associated with the straightforward use of the classic WFM concepts in systems engineering is that the domain-specific artifacts that are referred to from the workflow activities are typically under lifecycle management in their own designated disciplinary repositories

Consequently, by the time the workflow is actually executed, the artifact might have undergone changes including those that will make the execution of the workflow irrelevant if such changes are not taken into account. Therefore, there is a need to be able to define traceability links in a dynamic way and taking into account the individual lifecycles of artifacts. In particular, it is useful to be able to refer to future, currently inexistent, revisions of a specific artifact, or to delay the exact selection of an artifact revision to a later time.

3. Configuration selection rules

The traceability links between workflow activities and the artifacts may be static or dynamic. A link is static if it associates an activity with a specific revision of an artifact under the revision control of some repository. A link is dynamic if it is associated to an artifact in such a way that the actual revision of an artifact it is referring to is evaluated at the activity enactment time.

A simple example of a dynamic link is a link referring to the latest revision of an artifact in a specified branch of the artifact lifecycle tree. Such a dynamic link is useful because of the time difference between process workflow definition and workflow enactment. At enactment time, i.e., when the workflow is actually executed, the considered artifact might have gone through a number of revisions and therefore its latest revision on that stream of activities related to the said workflow might be different from its latest revision at the time of the workflow definition.

Dynamic links give more expressive power to the workflow designers by letting them refer to artifacts in a parametric way, taking into account the lifecycles of the artifacts that will actually get involved in the workflow at enactment time.

Another simple example of dynamic link is a link that is pointing to the unique revision of an artifact in lifecycle tree of revisions of the same artifact or that is currently marked with a unique tag or that is currently in a unique state. Since the revision associated with specified that might change between the times the workflow is defined and the workflow is enacted, it is indeed a dynamic link.

There are infinitely many ways to define dynamic links, but their definition is that they may be evaluated as static links at workflow enactment time and that the result of this evaluation is not surely predictable at workflow definition time.

Even more generally, a dynamic link might evaluate to another dynamic link and ultimately evaluate to a static link after multiple evaluations.

### SUMMARY OF THE INVENTION

The invention enables workflow management with dynamic artifacts. Artifacts are finite and identifiable pieces of digital information produced, consumed or transformed by product development processes. For instance, an artifact could be an abstraction, such as a CAD file, a digital representation of a process of simulating a product, or a record in a database of a design. In the context of the present invention, the term ‘dynamic’ means that the artifacts are under disciplinary lifecycle management (e.g., revision control) and ‘moving’ along their lifecycle trees. In this solution, a method template is developed to allow associating the artifact configuration selection rules with workflow activities, so that the right artifacts (revisions) from right location are configured, and available at workflow execution time.

In a first exemplary aspect of the present invention, a computer-implemented method supporting collaborative product development, that includes, maintaining under revision control, in a first repository, a plurality of artifacts, and in another repository, a plurality of artifact tuples. At least one first artifact tuple including first access information providing access to at least one of the plurality of artifacts, and at least one second artifact tuple including second access information providing access to at least one other of the plurality of artifact tuples. The method also maintains under revision control, at least one workflow activity description and at least one artifact configuration selection rule. The method further associates the workflow activity description with at least one of the plurality of artifact tuples, and associates the workflow activity description with the at least one artifact configuration selection rules.

The method further includes at least one workflow activity description maintained under revision control in an additional repository, and at least one artifact configuration selection rule maintained under revision control in an additional repository.

The method further includes associating at least two workflow activity descriptions with the at least one of the plurality of artifact tuples.

The method further includes associating the at least two workflow activity descriptions with the at least one artifact configuration selection rules.

The method further includes the workflow activity description associated with a specific revision of one of the plurality of artifact tuples.

The method further includes the workflow activity description associated with a specific revision of the artifact configuration selection rule.

The method further includes at least one artifact configuration selection rule includes an expression evaluating to one of a specific revision and a set of specific revisions corresponding to artifacts of the plurality of artifacts, wherein the workflow activity description is associated with at least one of the plurality of artifact tuples. The expression evaluating to one of a specific revision may evaluate to one of a unique revision corresponding to artifacts of the plurality of artifacts.

The method further includes the expression evaluates to a latest revision of a specific artifact of the plurality of artifacts, wherein the workflow activity description is associated with at least one of the plurality of artifact tuples. The expression evaluating to one of a specific revision may evaluates to one of a unique revision corresponding to artifacts of the plurality of artifacts.

The method further includes associating the at least one workflow activity description includes associating at least two specific revisions of at least two workflow activity descriptions with at least one specific revision of the at least one of the plurality of artifact tuples.

The method further includes deploying computing infrastructure in which computer-readable code is integrated into a computing system, such that the code and the computer system combine to perform the method of supporting collaborative product development.

In a second exemplary aspect of the present invention, a programmable storage medium tangibly embodying a program of machine-readable instructions executable by a digital processing apparatus to perform operations supporting collaborative product development, the operations including, maintaining under revision control, in a first repository, a plurality of artifacts, and maintaining under revision control, in another repository, a plurality of artifact tuples. At least one first artifact tuple includes first access information providing access to at least one of the plurality of artifacts, and at least one second artifact tuple including second access information providing access to at least one other of the plurality of artifact tuples. The program further includes maintaining under revision control, at least one workflow activity description, and at least one artifact configuration selection rule. The program further includes associating the workflow activity description with at least one of the plurality of artifact tuples, and associating the workflow activity description with at least one the artifact configuration selection rules.

The program further includes the at least one workflow activity description and the at least one artifact configuration selection rule is maintained under revision control in a plurality of repositories.

In a third exemplary aspect of the present invention, an apparatus for supporting collaborative product development, including, a plurality of repositories and means for maintaining, under revision control, a plurality of artifacts, a plurality of artifact tuples, at least one workflow activity description, and at least one artifact configuration selection rule, and for maintaining an association between the at least one workflow activity description with access information contained in at least one of the plurality of artifact tuples and with the at least one artifact configuration selection rule. The plurality of artifacts, the plurality of artifact tuples, the at least one workflow activity description, and the at least one artifact configuration selection rule are maintained in the plurality of repositories. And the at least one first artifact tuple including first access information provides access to at least one of the plurality of artifacts, and at least one second artifact tuple including second access information provides access to at least one other of the plurality of artifact tuples.

The apparatus further includes means for maintaining an association between the at least one workflow activity description with one of the first and the second access information.

The apparatus further includes means for maintaining an association between at least two workflow activity descriptions with the at least one artifact configuration selection rule.

The apparatus further includes means for maintaining an association between the at least one workflow activity description and a specific revision of one of the first and the second access information.

The apparatus further includes means for maintaining an association between the at least one workflow activity description and a latest revision of one of the first and second access information.

### BRIEF DESCRIPTION OF THE DRAWINGS

The foregoing and other exemplary aspects of embodiments of this invention are made more evident in the following Detailed Description of Exemplary Embodiments, when read in conjunction with the attached Drawing Figures, wherein:

FIG. 1 illustrates exemplary lifecycle trees containing multiple revisions for two different artifacts A and B.

FIG. 2 illustrates associations between workflow activities, tuples and artifacts (versions).

FIG. 3A illustrates an exemplary artifact lifecycle evolution during execution of process activities using configuration selection rules.

FIG. 3B illustrates an exemplary artifact lifecycle evolution during execution of process activities using configuration selection rules.

FIG. 3C illustrates an exemplary artifact lifecycle evolution during execution of process activities using configuration selection rules.

FIG. 4 illustrates a typical hardware configuration which may be used for implementing the system and method according to the exemplary aspects of the present invention.

FIG. 5 illustrates a programmable storage media for tangibly embodying a program of machine-readable instructions executable by a digital processing apparatus to perform the method according to the exemplary aspects of the present invention.

### DETAILED DESCRIPTION OF EXEMPLARY EMBODIMENTS OF THE INVENTION

In general, businesses involved in product development have a “product development” process (PD process). This PD process may be modeled using Business Process Modeling tools. Various steps in the PD process (also known as sub-process) may have workflows attached to them. In a sense, a “process” describes what needs to be done, and the “workflow” describes how to do it. Workflows are usually created and modified using a modeling component of a Workflow Management (WM) tool and are executed using the runtime engine component of the WM tool. The runtime engine of most WM tools operates on a notification-based system to guide the progress of the PD process or sub-processes Also, most WM tools have a notion of a lowest level ‘work’ that involves action(s) by a user(s) or other application system(s), (collectively known as “actors”), on one or more product related artifacts. This lowest level ‘work’ is referred to by various terms such as “task,” “activity,” etc., by different WM tools. Herein, this will be referred to as an activity.

One of the sources of common problems associated with complex product development processes is the lack of delivery of the right revision of the right artifacts to the right actors at the right time. Solving this problem involves:

1. Creating a traceability link between an activity and the artifact(s) it needs; and

2. Maintaining the integrity of the traceability link.

This invention addresses the ‘right revision’ issue.

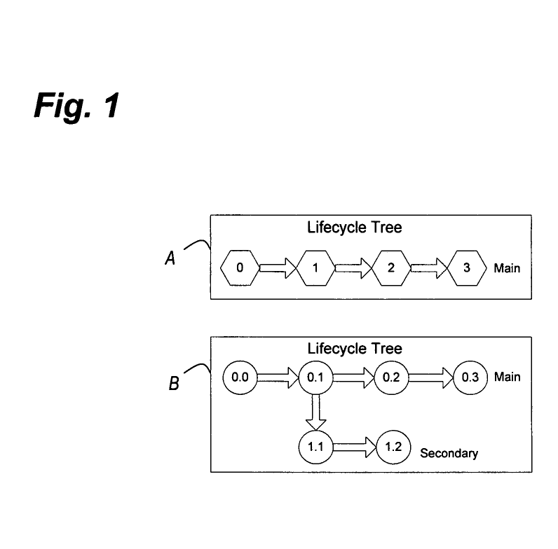

Referring now to the drawings, and more particularly to FIGS. 1-3C, there are shown exemplary embodiments of the method and structures of the present invention.

FIG. 1 illustrates exemplary lifecycle trees containing multiple revisions for two different artifacts A and B. Artifact A follows its lifecycle model which is a linear model as shown in FIG. 1, in which the latest revision of the artifact A is revision 3. Example types of artifact A are PDM artifacts, such as CAD models, CAE models, requirement artifacts, etc. Artifact B follows its lifecycle model which is a complex branch model. There are two branches in this example, the main branch and the secondary branch. The latest revision of the artifact B on the main branch is 0.3 and the latest revision on the secondary branch is revision 1.2. Typical artifact B-like artifacts may be software source code files authored and stored in SCM environment.

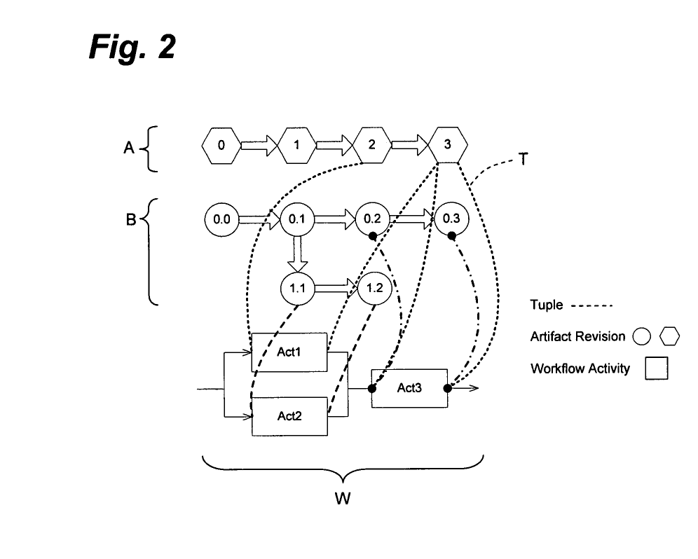

FIG. 2 illustrates associations between workflow or process activities W, tuples T and artifacts A and B and their revisions. While artifacts A and B are evolving along their lifecycle trees, one instance of execution is shown in FIG. 2. In this execution instance, artifact A is promoted from revision 2 to revision 3 during the course of activity Act1. These revisions are shown as input and output of Act1, respectively.

Similarly, a revision of artifact B is changed from 1.1 to 1.2 after activity Act2. Act3 works with artifact A without changing an artifact revision. The revision of artifact B available for activity Act3 at the moment of execution is not the same as the revision produced by activity Act2 prior to activity Act3. The reason is that while in the execution of workflow, concurrently, there may be multiple teams working on artifact B. As a result, a new revision (0.3) is added to the lifecycle tree.

Therefore, at the point of time of invocation of activity Act3, the latest revisions available are revision 0.2 and 1.2. Since Act3 asks for the latest revision on the main branch, revision 0.2 is selected as the input of Act3. Thereafter, a new revision of artifact B (0.3) is generated. After this workflow execution, the lifecycle trees are modified. If subsequent workflow executions are carried out, then each time, a completely different set of revisions of artifacts are available by the time each activity is to be executed, since these artifacts are evolving all the time. In these examples, each dynamic activity always asks for a latest revision of artifacts from a specified lifecycle tree branch.

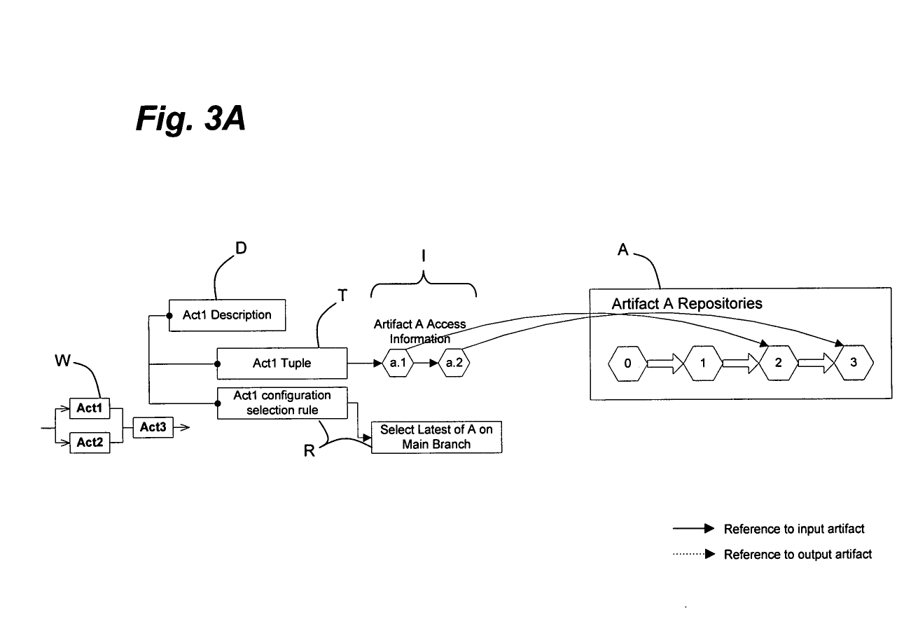

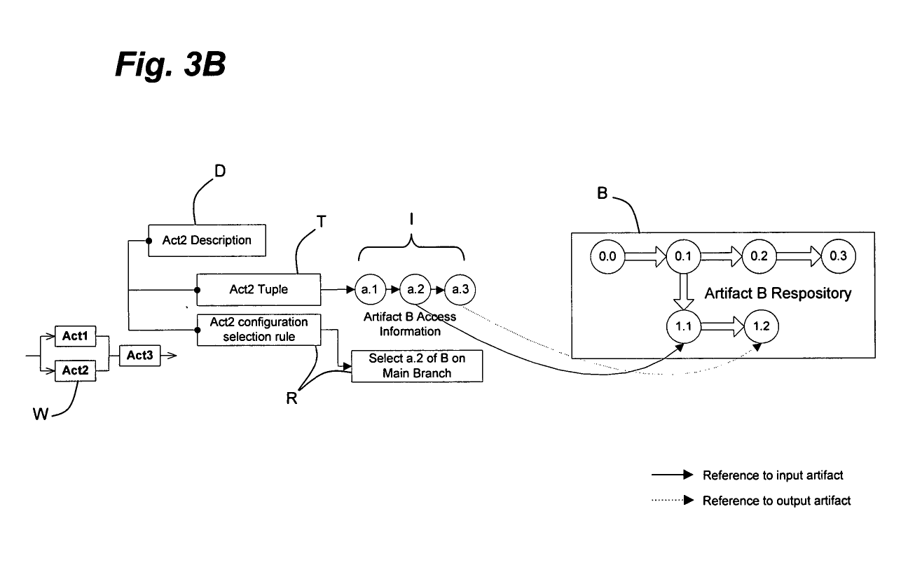

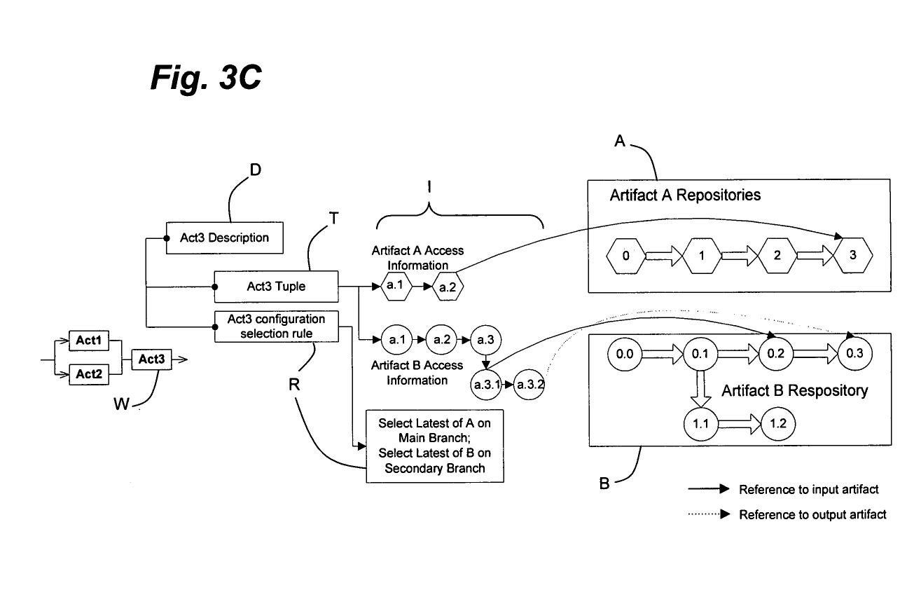

FIGS. 3A-3C illustrates an exemplary artifact lifecycle evolution during execution of process activities using configuration selection rules. In FIGS. 3A-3C, configuration rules select specific artifacts at workflow execution time. An activity description is defined to represent each workflow activity. An activity description is associated with an artifact tuple and a configuration selection rule. An artifact tuple is associated with access information to the artifacts involved in the associated activity.

For instance, in FIG. 3A, the Act1 description D is associated with an artifact tuple T and a configuration selection rule R, wherein the artifact tuple T is associated with access information I to artifact A. The artifact access information I itself is under revision control, with each revision pointing to a revision of the artifact A.

For example, artifact A access information I revision a.1 contains access information I to artifact A revision 2. Similarly, revision a.2 is referring to artifact A revision 3,

A configuration rule R, “Select Latest of A on Main Branch” is applied on selecting revisions of access information I of artifact A. This means to select the latest revision of access information I of artifact A on the main branch. The latest revision of access information I available at the moment of execution is a.1, which is referring to artifact A revision 2. Therefore, this particular revision of artifact A serves as an input for the Act1 execution.

In FIG. 3B, during execution of Act2, the configuration rule R, “Select a.2 of B on Main Branch,” indicates selection of a specific revision (a.2) of access information I for artifact B. This access information I is linked to artifact B revision 1.1, and this revision is used as an input for Act2 execution.

In FIG. 3C, the very last activity, Act3 works with both artifacts A and B. The tuple T associates with both access information I pointing to artifacts, A and B, respectively. Based on configuration rule R, “Select Latest of A on Main Branch,” and “Select Latest of B on Secondary Branch,” artifact A access information I revision a.2 and artifact B access information I revision a.3.1 are selected, and the associated artifact A revision 3 and artifact B revision 0.2 are finally used for Act3 execution.

In a technical sense, a workflow activity description is a data structure. In a conceptual sense, an instance of (more accurately, an instance of a revision of) workflow activity description is a representation of an instance of what is called an activity earlier in the SDM repository. Alternately, workflow activity description is a representation of a workflow activity. The workflow activity description may be created using an SDM application system or, more appropriately, through integration with a WM Tool at workflow creation time. The association with artifact tuples may be done manually (by establishing a link between instances of respective data structures) at workflow creation time or at a later stage by using the SDM application system.

In a technical sense, a configuration selection rule is a data structure. In a conceptual sense, an instance of (more accurately, an instance of a revision of) configuration selection rule is an expression including operators and operands. The configuration selection rule is created using the application system SDM application system. The association with workflow activity descriptions may be done manually, by establishing a link between instances of respective data structures, at workflow activity description creation time, or at a later stage by using the SDM application system. The configuration selection rule is used to traverse the evolutionary lifecycle tree of an artifact and select a specific revision of the artifact to associate with a specific workflow activity instance.

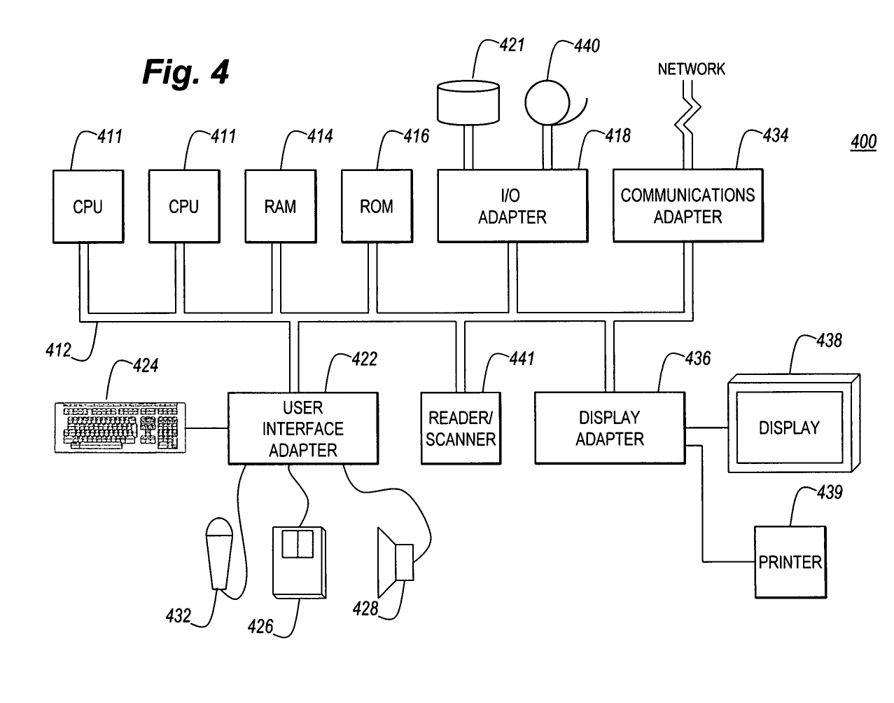

Referring again to the drawings, FIG. 4 illustrates a typical hardware configuration 400 which may be used for implementing the computer system and method according to the exemplary aspects of the present invention. The configuration has preferably at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, and Intranet, a personal area network (PAN), etc., and a display adapter 436 for connecting the bus 412 to a display device 438 and/or printer 439. Further, an automated reader/scanner 441 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 411 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 411 and hardware above, to perform the method of the invention.

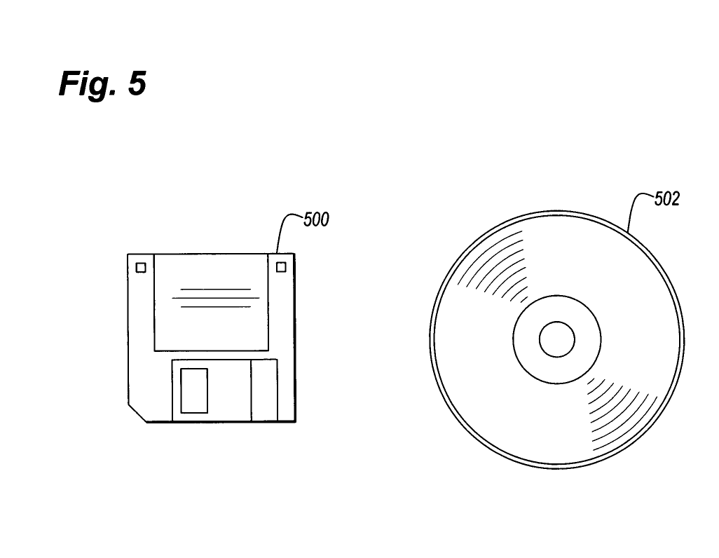

This signal-bearing media may include, for example, a RAM contained within the CPU 411, as represented by the fast-access storage for example. Alternatively, the instructions may be contained in another signal-bearing media, such as a magnetic data storage diskette 500 or CD-ROM 502, (FIG. 5), directly or indirectly accessible by the CPU 411.

Whether contained in the computer server/CPU 411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C” etc.

In this invention, as described above, a method is developed to allow associating the artifact configuration selection rules with workflow activities, so that the right artifacts (reversions) from right location are configured, and available at workflow execution time.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

We claim:

1. A computer-implemented method supporting collaborative product development, comprising:
maintaining under revision control, in a first repository, a plurality of artifacts;
maintaining under revision control, in another repository, a plurality of artifact tuples, at least one first artifact tuple comprising first access information providing access to at least one of said plurality of artifacts, and at least one second artifact tuple comprising second access information providing access to at least one other of said plurality of artifact tuples;
maintaining under revision control, at least one workflow activity description; and
maintaining under revision control, at least one artifact configuration selection rule; and
associating said workflow activity description with at least one of said plurality of artifact tuples; and
associating said workflow activity description with said at least one artifact configuration selection rules.

2. The computer-implemented method supporting collaborative product development of claim 1, wherein said at least one workflow activity description is maintained under revision control in an additional repository.

3. The computer-implemented method supporting collaborative product development of claim 1, wherein said at least one artifact configuration selection rule is maintained under revision control in an additional repository.

4. The computer-implemented method supporting collaborative product development of claim 1, wherein said associating said at least one workflow activity description with at least one of said plurality of artifact tuples comprises:
associating at least two workflow activity descriptions with said at least one of said plurality of artifact tuples.

5. The computer-implemented method supporting collaborative product development of claim 1, wherein said associating said workflow activity description with said at least one artifact configuration selection rule comprises:
associating said at least two workflow activity descriptions with said at least one artifact configuration selection rules.

6. The computer-implemented method supporting collaborative product development of claim 1, wherein said workflow activity description is associated with a specific revision of one of said plurality of artifact tuples.

7. The computer-implemented method supporting collaborative product development of claim 1, wherein said workflow activity description is associated with a specific revision of said artifact configuration selection rule.

8. The computer-implemented method supporting collaborative product development of claim 1, wherein said at least one artifact configuration selection rule comprises an expression evaluating to one of a specific revision and a set of specific revisions corresponding to artifacts of said plurality of artifacts, wherein said workflow activity description is associated with at least one of said plurality of artifact tuples.

9. The computer-implemented method supporting collaborative product development of claim 1, wherein said at least one artifact configuration selection rule comprises an expression evaluating to one of a latest revision and a set of latest revisions corresponding to artifacts of said plurality of artifacts, wherein said workflow activity description is associated with at least one of said plurality of artifact tuples.

10. The computer-implemented method supporting collaborative product development of claim 1, wherein said at least one artifact configuration selection rule comprises an expression evaluating to one of a unique revision and a set of unique revisions corresponding to artifacts of said plurality of artifacts, wherein said workflow activity description is associated with at least one of said plurality of artifact tuples.

11. The computer-implemented method supporting collaborative product development of claim 1, said method further comprising:
deploying computing infrastructure in which computer-readable code is integrated into a computing system, such that said code and said computer system combine to perform said method of supporting collaborative product development.

12. A programmable storage medium tangibly embodying a program of machine-readable instructions executable by a digital processing apparatus to perform operations supporting collaborative product development, the operations comprising:
maintaining under revision control, in a first repository, a plurality of artifacts;
maintaining under revision control, in another repository, a plurality of artifact tuples, at least one first artifact tuple comprising first access information providing access to at least one of said plurality of artifacts, and at least one second artifact tuple comprising second access information providing access to at least one other of said plurality of artifact tuples;
maintaining under revision control, at least one workflow activity description; and
maintaining under revision control, at least one artifact configuration selection rule;
associating said workflow activity description with at least one of said plurality of artifact tuples; and
associating said workflow activity description with at least one said artifact configuration selection rules.

13. The programmable storage medium of claim 12, wherein said at least one workflow activity description and said at least one artifact configuration selection rule is maintained under revision control in a plurality of repositories.

14. An apparatus for supporting collaborative product development, comprising:
a plurality of repositories; and
means for maintaining, under revision control, a plurality of artifacts, a plurality of artifact tuples, at least one workflow activity description, and at least one artifact configuration selection rule, and for maintaining an association between said at least one workflow activity description with access information contained in at least one of said plurality of artifact tuples and with said at least one artifact configuration selection rule,
wherein said plurality of artifacts, said plurality of artifact tuples, said at least one workflow activity description, and said at least one artifact configuration selection rule are maintained in said plurality of repositories, and
wherein at least one first artifact tuple comprising first access information provides access to at least one of said plurality of artifacts, and at least one second artifact tuple comprising second access information provides access to at least one other of said plurality of artifact tuples.

15. The apparatus for supporting collaborative product development of claim 14, wherein said means for maintaining further comprises:
means for maintaining an association between said at least one workflow activity description with one of said first and said second access information.

16. The apparatus for supporting collaborative product development of claim 14, wherein said means for maintaining further comprises:
means for maintaining an association between at least two workflow activity descriptions with said at least one artifact configuration selection rule.

17. The apparatus for supporting collaborative product development of claim 14, wherein said means for maintaining further comprises:
means for maintaining an association between said at least one workflow activity description and a specific revision of one of said first and said second access information.

18. The apparatus for supporting collaborative product development of claim 14, wherein said means for maintaining further comprises:
means for maintaining an association between said at least one workflow activity description and a latest revision of one of said first and second access information.
